(19) United States
(12) Patent Application Publication
(10) Pub. No.: US 2011/0134080 A1
(43) Pub. Date: Jun. 9, 2011

(54) OPTICAL POSITION DETECTION DEVICE AND PROJECTION DISPLAY DEVICE

(75) Inventor: Kanechika KIYOSE, Matsumoto (JP)

(73) Assignee: SEIKO EPSON CORPORATION, Tokyo (JP)

(21) Appl. No.: 12/962,112

(22) Filed: Dec. 7, 2010

(30) Foreign Application Priority Data
Dec. 9, 2009 (JP) 2009-279205

(51) Int. Cl. G06F 3/042; G01B 11/14

(52) U.S. Cl. 345/175; 356/614

(57) ABSTRACT

An optical position detection device includes: a light source section adapted to emit a position detection light beam to form a light intensity distribution in which the intensity varies along a reference surface; a light detection section adapted to detect the position detection light reflected by a detection target object located in a detection space in which the light intensity distribution is formed; and a position detection section adapted to detect a position of the detection target object based on a detection value of the light detection section, wherein the light detection section has a light receiving section provided with a light detection surface, and a light blocking section adapted to block a part of the position detection light, and the light blocking section has an opening section disposed between the detection space and the light detection surface with a distance from the light detection surface.

### BACKGROUND

1. Technical Field

The present invention relates to an optical position detection device and a projection display device.

2. Related Art

In general, in various types of display devices, those provided with a touch panel function, which makes it possible to perform input instructions by touching the display screen with fingers, styluses, or the like, have been increasing. Such a touch panel function can be implemented by disposing a touch panel on a display screen.

Such a touch panel function as described above can also be realized by an optical position detection device for obtaining the position of a detection target object by detecting the light (see, e.g., the specifications of U.S. Pat. Nos. 5,666,037 and 6,927,384). In such an optical position detection device, it is arranged that the position detection light beam is emitted from a light emitting element, then the position detection light beam reflected by the detection target object on a display screen is detected by a light detector, and the position of the detection target object is obtained by using the light detection value thereof.

However, according to the optical position detection device described above, since the position detection light other than the position detection light reflected by the intended detection target object such as a fingertip or a tip of a stylus as a pointing region enters the light detector, the position of the detection target object might not be obtained accurately in some cases. For example, since it is not achievable to accurately detect the intensity of the position detection light beam reflected by the detection target object due to the position detection light beam emitted from the display screen and then directly entering the light detector, it becomes unachievable to accurately obtain the position of the detection target object. On this occasion, since the position detection light beam other than the position detection light beam reflected by the detection target object does not at all reflect the position of the detection target object, even if the intensity of the light beam is low, the detection accuracy of the position of the detection target object is affected significantly. Further, unlike other environmental light such as outside light, the position detection light beam other than the position detection light beam reflected by the detection target object cannot be eliminated even by the method of modulating the position detection light beam and performing the light detection according to the type of the modulation.

Further, in an actual position detection environment, the position detection light beam reflected by a region other than the pointing region as the intended detection target for position detection such as a fingertip or a tip of a stylus, namely a hand or arm, for example, might enter the light detector in some cases. Such a position detection light beam degrades the position detection accuracy of the intended pointing region, and at the same time is unable to be eliminated in the configuration of the related art.

### SUMMARY

An advantage of some aspects of the invention is to prevent the detection accuracy of the position of a detection target object due to the position detection light beam other than the reflected light beam from the detection target object.

According to an aspect of the invention, there is provided an optical position detection device adapted to optically detect the detection target object disposed in a detection space set in an upper position of the reference surface composed of at least a part of an object surface including a position detecting light source adapted to emit a position detection light beam to form a light intensity distribution, which varies in accordance with a position along the reference surface, in the detection space, a light detector disposed at a lateral position of the detection space, and adapted to detect the position detection light reflected by the detection target object in the detection space, and a position detection section adapted to detect a position of the detection target object based on a light detection value of the light detector, wherein the light detector has a detector main body provided with a light detection surface, and a light blocking structure adapted to block at least a part of the position detection light beam in the light detection surface on the side of the detection space, and the light blocking structure blocks at least apart of the position detection light beam emitted from the reference surface and directly entering the light detection surface from entering the light detection surface.

According to this aspect of the invention, since at least a part of the position detection light beam emitted from the reference surface and directly entering the light detection surface is blocked by the light blocking structure, an influence of the position detection light beam, which enters directly from the reference surface, to the light detection value can be reduced, and therefore, the accuracy of the position detection of the detection target object can be improved.

In this aspect of the invention, it is preferable that the light blocking structure completely blocks the position detection light beam emitted from the reference surface and directly entering the light detection surface from entering the light detection surface. According to this configuration, since the light blocking structure completely blocks the position detection light beam emitted from the reference surface and entering directly, it becomes possible to detect the position of the detection target object with further accuracy.

In this aspect of the invention, it is preferable that the light blocking structure is formed of a light blocking member covering the light detection surface and having an opening section disposed with a distance from the light detection surface on the side of the detection space. According to this configuration, by using the light blocking member having the opening section on the side of the detection space, it becomes possible to limit the incident angle range of the position detection light beam proceeding from the side of the detection space toward the light detection surface in accordance with the opening range of the opening section and the distance between the light detection surface and the opening section, and therefore, it becomes possible to easily set the blocking range by the light blocking structure. It should be noted that it is sufficient for the opening section to be an optical opening section capable of allowing passage of or transmitting the position detection light beam, and therefore, the opening section can be formed of a window section capable of transmitting the position detection light beam instead of a physical opening section. For example, by forming the opening section of the window section, which transmits the light beam (e.g., an infrared light beam) with the wavelength range of the position detection light beam while blocking the light beam (e.g., visible light beam) with other wavelengths, the detection sensitivity and an S/N ratio of the detection can be improved.

In this case, assuming that afar side boundary point is a point on the reference surface furthest from the opening section in all planar directions along the reference surface and proceeding from the light detection surface toward the opening section, the distance between the opening section and the far side boundary point measured in a direction along a projection line of a straight line to the reference surface is x1, the straight line connecting the opening edge of the opening section on the side of the reference surface and the far side boundary point, the distance between the opening section and a reached point of the straight line on the light detection surface or the extended surface thereof measured in a direction along the projection line is x2, the distance between the reference surface and the opening edge measured in a direction perpendicular to the reference surface is z1, and the distance between the outer edge position of the light detection surface on the opposite side to the reference surface and the opening edge measured in a direction perpendicular to the reference surface is z2, the formula 1 below is desirably satisfied.

z2≦z1·x2/x1 (1)

According to this configuration, when considering the straight line extending from the far side boundary point on the reference surface, passing through the opening edge of the opening section on the reference surface, and reaching the light detection surface or the extended surface thereof, if the formula 1 is satisfied, the straight line fails to intersect the light detection surface, and therefore, it becomes that all of the light beams emitted from the reference surface fail to directly reach the light detection surface. Therefore, it becomes that the position detection light beam emitted directly from the reference surface fails to be detected by the light detector.

In this aspect of the invention, it is preferable that the light detection surface has a part disposed on a side of the reference surface from the opening edge viewed from a direction perpendicular to the reference surface. According to this configuration, if the light detection surface has the part disposed on the side of the reference surface from the opening edge, the light beam entering from the side of the reference surface is blocked by the light blocking structure so as not to enter the part directly, and at the same time, the reflected light from the detection target object disposed in a region in the detection space further from the reference surface than the opening section enters the part directly. Therefore, it becomes possible to reduce the noise when detecting the position, and to improve the sensitivity to the signal corresponding to the position of the detection target object.

In this aspect of the invention, it is preferable that the light blocking member has an opening edge in the entire periphery of the opening section, and completely covers the light detection surface except the opening section. According to this configuration, since it is possible to limit the incident angle range with the light detection surface not only of the position detection light beam entering from the side of the reference surface but also of the position detection light beam entering from the opposite side to the reference surface or the position detection light beam entering from the planar directions along the reference surface, the accuracy of position detection of the detection target object can further be improved. In particular, in some cases, by limiting the incident angle range, entrance of the position detection light beam reflected by a region different from the intended detection target region of the detection target object can also be restricted.

In this aspect of the invention, it is preferable that the light blocking member is provided with an inner surface absorbing the position detection light beam. According to this configuration, since the inner surface of the light blocking member absorbs the position detection light beam, it is possible to prevent the light beam other than the light beam directly entering the light detection surface from being reflected by the inner surface and reaching the light detection surface indirectly even if the light beam is the position detection light entering the opening section.

In this aspect of the invention, it is preferable that the reference surface is composed of at least a part of a surface of a light guide member, and the position detection light beam is emitted from the reference surface after propagating through the inside of the light guide member. According to this configuration, since the position detection light beam is emitted from the reference surface, it is possible to efficiently direct the reflected light beam from the detection target object disposed in the detection space set on the reference surface toward the light detector disposed on the lateral side of the detection space. Further, since the emission intensity of the position detection light beam from the reference surface increases on this occasion, the advantages of the invention due to the configuration described above can be enhanced.

In this case, it is also possible to adopt the configuration in which the position detecting light sources are disposed so as to be opposed to the edge face of the light guide member, and the position detection light beam enters the inside of the light guide member from the edge face. Further, it is also possible to adopt the configuration in which the position detecting light sources are disposed so as to be opposed to the opposite surface of the light guide member to the reference surface, and the position detection light beam enters the inside of the light guide member from the surface on the opposite side to the reference surface.

In this aspect of the invention, it is preferable that the position detecting light sources emit the position detection light beam from the side opposed to the reference surface toward the reference surface, and the reference surface reflects the position detection light beam. In this case, the position detection light beam emitted from the reference surface is the light beam reflected by the reference surface.

A projection display device according to another aspect of the invention includes either one of the optical position detection devices described above, a screen provided with the reference surface, and an image projection device adapted to project an image to the screen. In this case, it is preferable that the reference surface is disposed in the range limited on the side of the light detector from an outer edge position of the projection range of the image on the side opposite to the light detector. As described above, since the reference surface is disposed so as to be limited to the side of the light detector from the outer edge position of the projection range of an image on the opposite side to the light detector, the range from which the position detection light beam is emitted is limited to the side of the light detector. Therefore, it becomes possible to easily perform the light blocking to the position detection light beam emitted from the reference surface.

Further, in some cases, the position detecting light sources might be disposed in the image projection device. According to this configuration, by providing the position detecting light sources to the image projection device, it becomes easy to apply the position detection light beam to the region of the screen overlapping the image projection range by the image projection device.

Further, it is preferable that the light detector is attached to the screen. According to this configuration, the light detector can easily be disposed and fixed to the lateral side of the detection space.

According to the aspects of the invention, there can be provided an excellent advantage that the deterioration of the detection accuracy of the position of the detection target object due to the position detection light beam other than the reflected light beam from the detection target object can be prevented.

### BRIEF DESCRIPTION OF THE DRAWINGS

The invention will be described with reference to the accompanying drawings, wherein like numbers reference like elements.

FIG. 1 is a schematic perspective view schematically showing an appearance of a projection display device according to an embodiment of the invention viewed from a viewer side.

FIG. 2 is a schematic side view schematically showing an appearance of the projection display device according to the embodiment of the invention viewed from a lateral side.

FIG. 3 is a schematic front view schematically showing a position detection range of the present embodiment of the invention.

FIG. 4 is a schematic perspective view schematically showing an appearance of an image projection device according to the embodiment of the invention viewed from a light exit side.

FIG. 5 is a schematic configuration explanatory diagram schematically showing a configuration of the image projection device according to the present embodiment of the invention.

FIGS. 6A and 6B are respectively a schematic cross-sectional view and an explanatory diagram each showing schematically a positional relationship between a reference surface and a light detector in the present embodiment of the invention.

FIG. 7 is a schematic cross-sectional view schematically showing a positional relationship between a reference surface and a light detector in another embodiment of the invention.

FIG. 8 is a schematic cross-sectional view schematically showing the positional relationship between the reference surface and the light detector in each of the embodiments of the invention.

FIG. 9 is a schematic cross-sectional view schematically showing a positional relationship between a reference surface and a light detector in a different embodiment of the invention.

FIG. 10 is a schematic cross-sectional view schematically showing a positional relationship between a reference surface and a light detector in a further different embodiment of the invention provided with a detection range limited with respect to a display range.

FIG. 11 is a schematic cross-sectional view schematically showing a positional relationship between a reference surface and a light detector in another embodiment of the invention.

FIG. 12 is a schematic cross-sectional view schematically showing a positional relationship between a reference surface and a light detector in still another embodiment of the invention.

FIG. 13 is a schematic cross-sectional view schematically showing a positional relationship between a reference surface and a light detector in a further different embodiment of the invention.

FIGS. 14A through 14C are explanatory diagrams for explaining a position detection method.

FIG. 15 is a schematic circuit diagram showing a configuration example of a detection circuit.

FIG. 16 is an explanatory diagram showing how the detection circuit operates.

### DESCRIPTION OF EXEMPLARY EMBODIMENTS

Then, some embodiments of the invention will be explained in detail with reference to the accompanying drawings. It should be noted that although in the embodiments described below, an optical position detection device is applied to a projection display device, the invention is applied not only to the projection display device, but also to various types of display devices, various types of operation devices, and so on.

### Overall Configuration of Projection Display Device

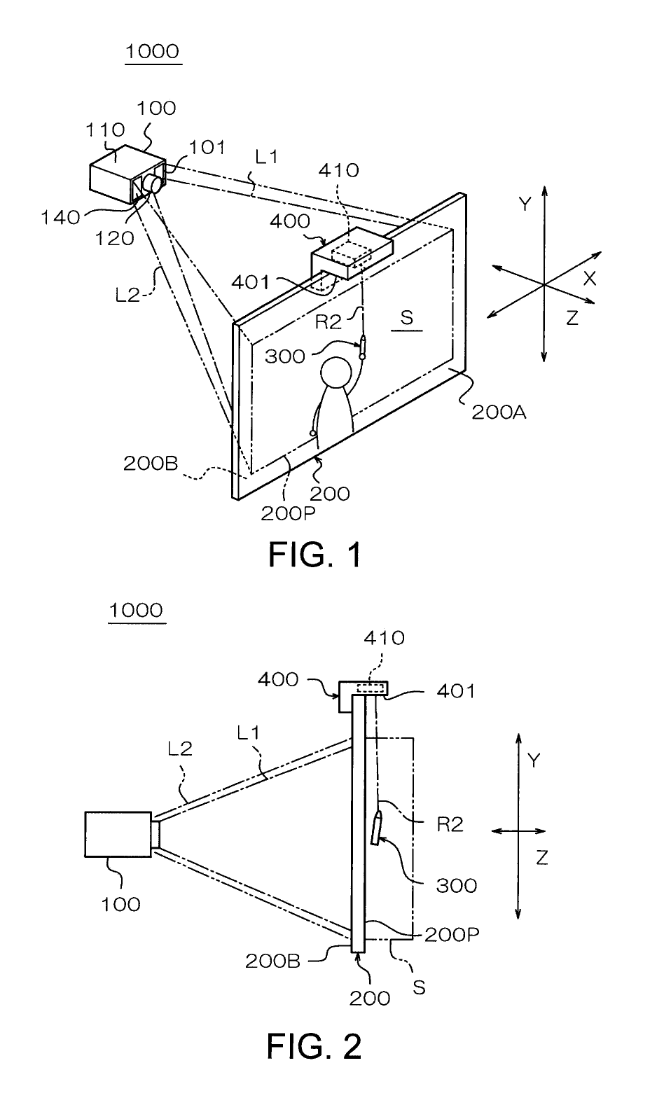

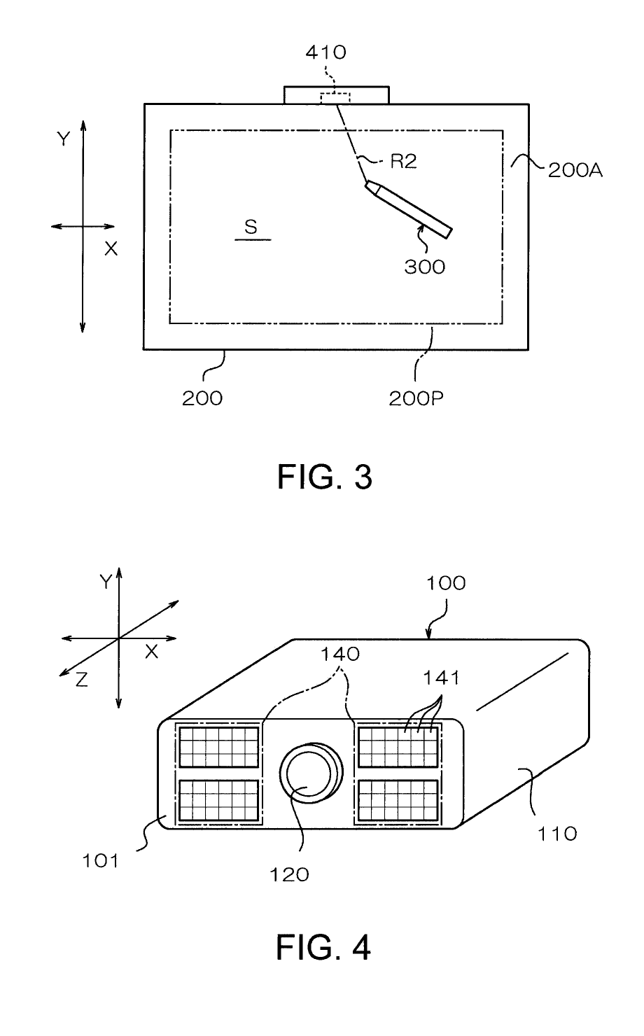

FIG. 1 is a schematic perspective view schematically showing an appearance of the projection display device according to the present embodiment of the invention viewed from a viewer side, FIG. 2 is a schematic side view schematically showing an appearance of the projection display device according to the present embodiment viewed from a lateral side, and FIG. 3 is a schematic front view schematically showing an appearance of the projection display device according to the present embodiment viewed from a viewer side. As shown in FIGS. 1 through 3, the projection display device 1000 provided with the optical position detection device according to an aspect of the invention has an image projection device 100, a screen 200 to which a light beam emitted from the image projection device 100 is projected, and a detection device 400 for receiving a reflected light beam R2 from a detection target object 300 disposed on the screen 200.

It should be noted that in FIGS. 1 through 3 things are displayed assuming that the lateral direction (the horizontal direction) is an X-axis direction, the vertical direction is a Y-axis direction, and the direction along which the light beam of the image projection device 100 is emitted toward the screen 200 is a Z-axis direction for the sake of convenience of explanation, and the X-axis, the Y-axis, and the Z-axis intersect (perpendicularly to each other in the example shown in the drawings) each other.

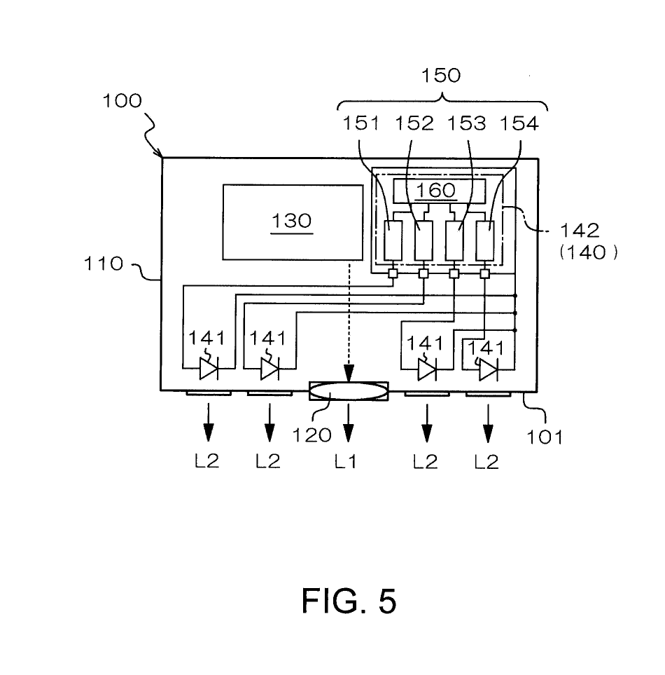

The image projection device 100 is a liquid crystal projector or a digital micromirror device, and is configured so as to emit an image display light beam L1 from a projection lens 120 disposed on a front portion 101 of a housing 110 toward a rear surface 200B of the screen 200 in an enlarged manner. Therefore, as shown in FIG. 5, the image projection device 100 is provided with an optical device 130 disposed inside the housing 110, the optical device generating a color image display light beam L1 and then emitting it via the projection lens 120.

Further, as shown in FIGS. 1 and 4, the image projection device 100 is provided with a position detection light source section 140 (a position detecting light source) for emitting a position detection light beam L2, the infrared light beam, toward the screen 200. The position detection light source section 140 forms an intensity distribution of the position detection light beam L2 in a detection space S described later.

As shown in FIGS. 4 and 5, the position detection light source section 140 of the image projection device 100 has a plurality of light emitting elements 141 for emitting infrared light beams, and a light source drive section 142 for driving the plurality of light emitting elements 141.

As shown in FIGS. 1 and 4, the light emitting elements 141 are, for example, light emitting diodes (LED), and are disposed on both sides of the projection lens 120 in the front portion 101 of the image projection device 100. The light emitting elements 141 emit the position detection light beam L2. The position detection light beam L2 is composed of, for example, the infrared light beams, and is provided with the wavelength distribution including a wavelength band from about 800 nm to 1000 nm.

As shown in FIG. 5, the light source drive section 142 is provided with a light source drive circuit 150 for driving the plurality of light emitting elements 141, and a light source control section 160 for controlling the emission intensities of the light emitting elements 141 via the light source drive circuit 150. Among these components, the light source drive circuit 150 is composed of, for example, a first light source drive circuit 151, a second light source drive circuit 152, a third light source drive circuit 153, and a fourth light source drive circuit 154, and these circuits are electrically connected respectively to the discrete light emitting elements 141 or the light emitting element groups composed of a plurality of light emitting elements 141 formed inside the position detection light source section 140 described above. As described above, it is arranged that the intensity distribution of the position detection light beam L2 emitted from the position detection light source section 140 is set or modified appropriately by driving the light emitting elements 141 or the light emitting element groups in the position detection light source section 140 using the respective light source drive circuits 151 through 154.

Further, as shown in FIGS. 1 through 3, the screen 200 has a landscape rectangular shape, and is made of transmissive synthetic resin such as acrylic, and is configured so as to display the image light beam L1 entering from the rear surface 200B on the front surface 200A as an image. Further, the screen 200 is configured so as to emit the position detection light beam L2, which is input from the rear surface 200B, from the reference surface 200P, which is at least apart of the front surface 200A to thereby form the detection space S on the reference surface 200P.

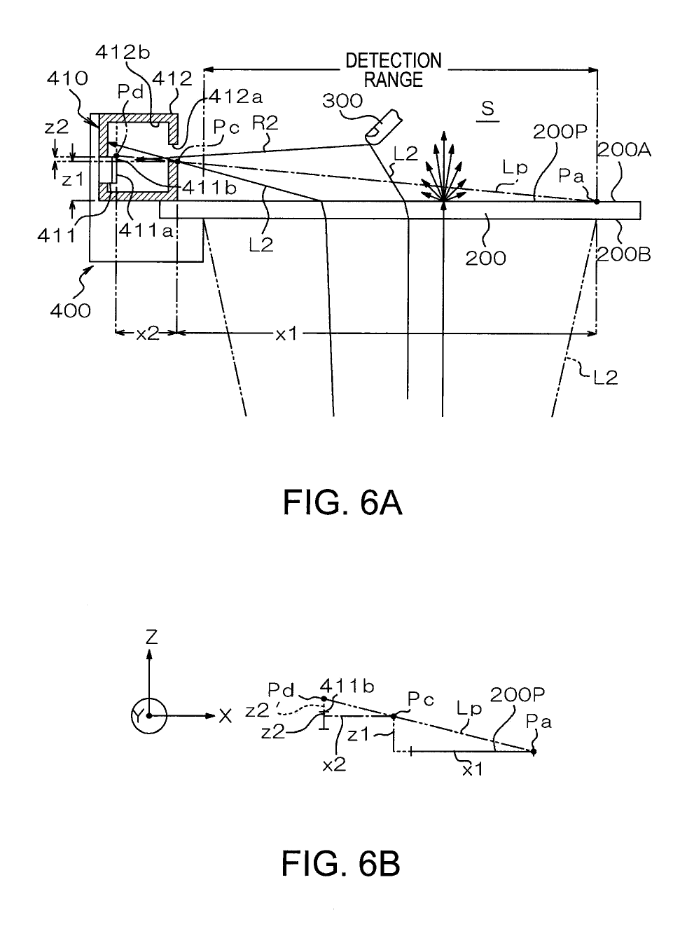

Then, although the detection target object 300 is not particularly limited, a pointing member (a stylus) for pointing an arbitrary position on the reference surface 200P will be described as an example, for example, as shown in FIGS. 1 through 3. At least a detection target region (a tip portion in the drawings) of the detection target object 300 is configured so as to reflect the position detection light beam L2. Further, the region (the shaft portion other than the tip portion) other than the detection target region of the detection target object 300 is provided with a surface material for absorbing the infrared light disposed on the surface thereof, for example, and is configured so as not to reflect the position detection light beam L2. Therefore, it is arranged that the detection target region of the detection target object 300 alone reflects the position detection light beam L2. It should be noted that since the detection target object 300 is illustrated in FIGS. 1 through 3, and 15 as the pointing member (the stylus), it is also possible to use a human body such as a finger as the detection target object. In FIGS. 6A, 6B, 7, and 10 through 13 referred to later, a finger is illustrated as the detection target object. By using an infrared light beam as the position detection light beam L2 as described above, the position detection light beam L2 can sufficiently be reflected also with the finger.

As shown in FIGS. 1 through 3, the detection device 400 is disposed at the center portion of the upper end of the screen 200, and the detection device 400 is provided with a light detector 410, which is disposed on a lateral side of the detection space S disposed on the reference surface 200P and has a light detection surface directed toward the detection space S. The light detector 410 detects a reflected light beam R2 which is the position detection light beam L2 reflected by the detection target object 300, and then outputs a light detection signal.

The light detector 410 is disposed at a bottom section 401 of the detection device 400, the bottom section 401 being located on the side of the screen 200. This configuration is adopted in order for making it easy for the reflected light beam R2 emitted from the detection space S to enter the light detection surface. The light detector 410 can be composed of a photodiode, a phototransistor, or the like, and a photodiode is used in the present embodiment.

### Fundamental Principle of Position Detection

Then, the fundamental principle of the position detection used in the present embodiment, namely the method of deriving the position information of the detection target object 300 in the detection space S performed by the optical position detection device applied in the present embodiment, will be explained.

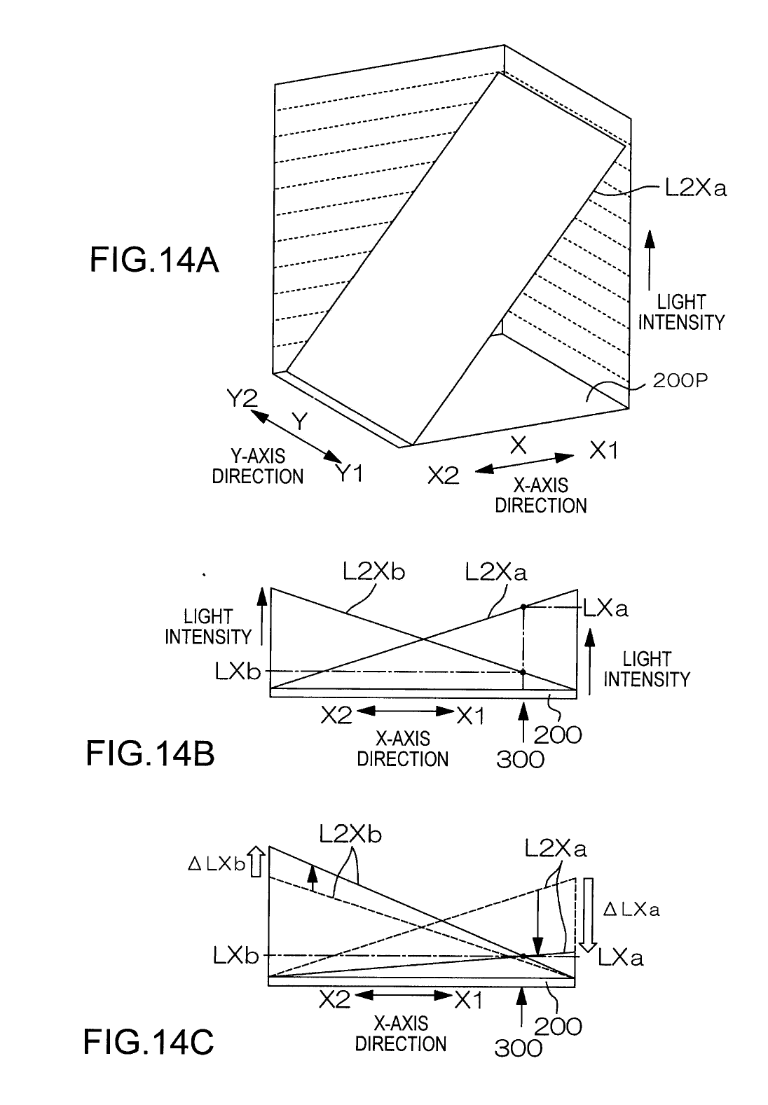

FIGS. 14A through 14C are explanatory diagrams for explaining the fundamental principle of the position detection described above, wherein FIG. 14A is an explanatory diagram showing an example of a light intensity distribution of the position detection light beam L2, FIG. 14B is an explanatory diagram showing the relationships between the position coordinate of the detection target object 300 and the light intensity of the reflected light beam R2 of the position detection light beam L2 reflected by the detection target object 300 in two light intensity distributions, and FIG. 14C is an explanatory diagram showing a method of adjusting the two light intensity distributions so that the light intensities of the reflected light beam R2 in the two light intensity distributions become equal to each other.

In the optical position detection device according to the present embodiment, when the position detection light beam L2 is emitted from the plurality of light emitting elements 141 of the position detection light source section 140, the intensity distribution of the position detection light beam L2 is formed in the detection space S on the reference surface 200P set in the front surface 200A of the screen 200 in accordance with a combination (an emission pattern) of the emission intensities of the plurality of light emitting elements 141. For example, when detecting the X-coordinate, as shown in FIG. 14A, a first light intensity distribution L2Xa for detecting the X-coordinate, in which the intensity is gradually decreased in the X-axis direction from one side X1 toward the other side X2, is firstly formed in a first period. Here, in the example shown in the drawings, the first light intensity distribution L2Xa is provided with a light intensity distribution constant in the Y-axis direction. Further, in a second period subsequent thereto, a second light intensity distribution L2Xb for detecting the X-coordinate, in which the intensity gradually decreases in the X-axis direction from the other side X2 toward the one side X1, is formed. The second light intensity distribution L2Xb is also provided with a light intensity distribution constant in the Y-axis direction.

Here, it is preferable to configure the light intensity distribution described above so that the light intensity varies linearly in the X-axis direction from the one side X1 toward the other side X2. In other words, the light intensity decreases linearly in the X-axis direction from the one side X1 toward the other side X2 in the first light intensity distribution L2Xa in the first period, and the light intensity decreases linearly in the X-axis direction from the other side X2 toward the one side X1 in the second light intensity distribution L2Xb in the second period.

If the detection target object 300 is disposed in the detection space S in this condition, the position detection light beam L2 is reflected by the detection target object 300, and some of the reflected light beam R2 is detected by the light detector 410. In this case, by previously setting the first light intensity distribution L2Xa and the second light intensity distribution L2Xb to predetermined distribution patterns, the X-coordinate of the detection target object 300 can be detected using either of the following methods.

A first position detection method is a method of using the difference between the first light intensity distribution L2Xa and the second light intensity distribution L2Xb as shown in FIG. 14B. Specifically, since it is arranged that the first light intensity distribution L2Xa and the second light intensity distribution L2Xb previously have the predetermined distribution patterns as described above, the difference between the first light intensity distribution L2Xa and the second light intensity distribution L2Xb also becomes the function of the X-coordinate having a pattern set previously. Therefore, by obtaining the difference between the light detection value LXa of the light detector 410 when forming the first light intensity distribution L2Xa in the first period and the light detection value LXb of the light detector 410 when forming the second light intensity distribution L2Xb in the second period, the X-coordinate of the detection target object 300 can be detected. It should be noted that since the ratio between the light detection values LXa, Lxb also becomes a function of the X-coordinate, it is also possible to detect the X-coordinate by obtaining the ratio.

Then, a second position detection method is a method of using the adjustment amounts in the case of adjusting the drive currents of the plurality of light emitting elements 141 so that the light detection value LXa detected in the first light intensity distribution L2Xa and the light detection value LXb detected in the second light intensity distribution L2Xb become equal to each other. It should be noted that the second method can be applied to the case shown in FIG. 14B in which the first light intensity distribution L2Xa and the second light intensity distribution L2Xb vary linearly with respect to the X-coordinate.

As shown in FIG. 14B, firstly, the first light intensity distribution L2Xa and the second light intensity distribution L2Xb are formed in the first period and the second period so as to have the absolute values equal to each other and the directions reverse to each other along the X-axis direction. In this state, if the light detection value LXa in the first light intensity distribution L2Xa and the light detection value LXb in the second light intensity distribution L2Xb are equal to each other, it turns out that the detection target object 300 is located at the center in the X-axis direction.

In contrast thereto, if the light detection values LXa, LXb are different from each other as shown in FIG. 14C, the drive currents to the light emitting elements 141 in either one or both of the first and second periods are adjusted so that the both parties become equal to each other, and then the first light intensity distribution L2Xa is formed again in the first period, and the second light intensity distribution L2Xb is formed again in the second period. As a result, if the light detection values LXa, LXb become equal to each other, the X-coordinate of the detection target object 300 can be detected based on the ratio or the difference between the adjustment amount ΔLXa in the first period and the adjustment amount ΔLXb in the second period, or the ratio or the difference between the control amount to the light emitting elements 141 in the first period after the adjustment and the control amount to the light emitting elements 141 in the second period after the adjustment.

In either of the cases of respectively adopting the first and second methods, by forming the first light intensity distribution (the intensity is constant in the X-axis direction) for detecting the Y-coordinate in which the light intensity decreases gradually in the Y-axis direction from one side Y1 toward the other side Y2 in the third period, and then forming the second light intensity distribution (the intensity is constant in the X-axis direction) for detecting the Y-coordinate in which the light intensity decreases gradually in the Y-axis direction from the other side Y2 toward the one side Y1 in the fourth period similarly to the method of detecting the X-coordinate described above, the Y-coordinate of the detection target object 300 can be detected. Further, by forming the light intensity distribution in the Z-axis direction in the fifth period, the Z-coordinate of the detection target object 300 can be detected. It should be noted that in the fifth period it is possible to drive all of the light emitting elements 141 of the position detection light source section 140 so as to have the same emission amount, thereby forming the intensity distribution in which the intensity is approximately constant in both of the X-axis and Y-axis directions while the intensity varies in the Z-axis direction.

It should be noted that in either of the cases of the first method and the second method, since the intensity of the environment light is canceled out when obtaining the difference between the light detection values LXa, LXb or when performing the adjustment so that the light detection values LXa, LXb become equal to each other even if the infrared component included in the environment light enters the light detector 410, the environment light never exerts an influence on the detection accuracy.

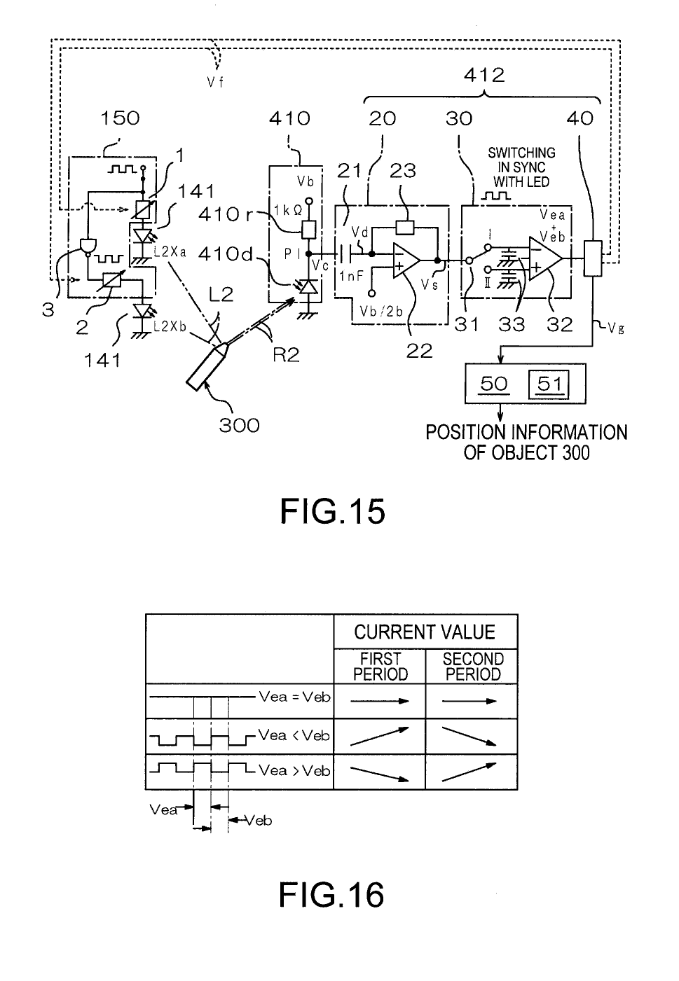

FIG. 15 is a schematic circuit diagram showing an example of a signal processing circuit of the position detection section formed inside the image projection device 100 and the detection device 400 described above included in the optical position detection device according to the present embodiment. In the explanation of the operation and the advantages of the signal processing circuit described here, since the case of detecting the X-coordinate of the detection target object 300 and the case of detecting the Y-coordinate thereof are substantially the same, the case of obtaining the X-coordinate of the detection target object 300 will be explained alone.

The light source control circuit 160 shown in FIG. 5 of the present embodiment outputs a pulse signal to be a reference, and as shown in FIG. 15, the light source drive circuit 150 applies the drive pulses with predetermined current values to the respective light emitting elements 141 via variable resistors 1 in the first period based on the pulse signal, and applies the drive pulses with predetermined current values to the respective light emitting elements 141 via variable resistors 2 and the inverter circuits 3 in the second period based on the pulse signal. Therefore, as a result, the light source drive circuit 150 applies the drive pulses with the phases reversed to each other to the light emitting elements 141 in the first period and the second period, respectively. Further, the position detection light beam L2 emitted when forming the first light intensity distribution L2Xa in the first period is reflected by the detection target object 300 to form the reflected light beam R2, and some of the reflected light beam R2 is detected by a light receiving element 410d such as a photodiode of the light detector 410. Similarly, the reflected light beam R2 obtained when forming the second light intensity distribution L2Xb in the second period is detected by the light detector 410.

It should be noted that in the light detector 410 the light receiving element 410d is electrically connected in series to the resistor 410r with the resistance of about 1 kΩ, and a bias voltage Vb is applied to the both terminals of the series circuit. A signal extraction circuit 20 is electrically connected to a connection point between the light receiving element 410d and the resistor 410r. A detection signal Vc output from the connection point is an alternating-current signal corresponding to the pulse signal described above and provided with a level and amplitude both reflecting the light receiving intensity of the light receiving element 410d.

The detection circuit 412 is connected to the output of the light detector 410, and is provided with the signal extraction circuit 20 for taking out the light detection signal from the detection signal Vc, a signal separation circuit 30 connected to the output of the signal extraction circuit 20 and adapted to separate the light detection value in sync with the pulse signal of the light source control section 160, and a signal processing circuit 40 connected to the output of the signal separation circuit 30 and adapted to form a signal related to the position information.

The signal extraction circuit 20 is provided with a filter 21 composed of a capacitor of about 1 nF, and the filter 21 functions as a high-pass filter for eliminating a direct current component from the signal output from the connection point PI between the light receiving element 410d and the resistor 410r. Therefore, the filter 21 extracts a position detection signal Vd as an alternating-current component of the voltage Vc from the detection signal Vc output from the connection point PI. In other words, since the intensity of the environment light can be regarded as constant in a certain period while the position detection light beam L2 is modified, the low-frequency component or the direct current component due to the environment light is eliminated by the filter 21.

Further, the signal extraction circuit 20 has an adder circuit 22 provided with a feedback resistor 23 of about 220 kΩ disposed in the posterior stage of the filter 21, and the position detection signal Vd extracted by the filter 21 is output to the position detection signal separation circuit 30 as a position detection signal Vs obtained by superimposing with the voltage V/2 half as high as the bias voltage Vb.

The signal separation circuit 30 is provided with a switch 31 performing a switching operation in sync with the drive pulse applied to the light emitting elements 141 in the first period, a comparator 32, and capacitors 33 electrically connected to the respective input lines of the comparator 32. Therefore, when the position detection signal Vs is input to the signal separation circuit 30, the effective value Vea of the detection signal Vs in the first period and the effective value Veb of the position detection signal Vs in the second period are alternately output from the signal separation circuit 30 to the signal processing circuit 40.

The signal processing circuit 40 is for obtaining the difference between the effective value Vea in the first period and the effective value Veb in the second period, and outputs the difference to a position determination section 50 as a position detection signal Vg. A storage section 51 of the position determination section 50 contains the function values of the difference between the X-coordinate detecting first intensity distribution L2Xa and the X-coordinate detecting second intensity distribution L2Xb in the X-axis direction throughout the detection space S, and it is possible to check off the position detection signal Vg with the function values to find out the corresponding X-coordinate, and thus obtaining the X-coordinate of the detection target object 300.

It should be noted that in the case of realizing the second method in the fundamental principle of the coordinate detection described above, namely the method of detecting the X-coordinate of the detection target object 300 based on the adjustment amounts obtained when adjusting the control amounts (the drive currents) to the light emitting elements 141 so that the detection values LXa, LXb in the light detector 410 in the respective first and the second periods become equal to each other, it is arranged that the control signal Vf is output from the signal processing circuit 40 to the light source drive circuit 150 of the image projection device 100 so that the effective value Vea of the position detection signal Vs in the first period and the effective value Veb of the position detection signal Vs in the second period become in the same level.

On this occasion, as shown in FIG. 16, the effective value Vea in the first period and the effective value Veb in the second period are compared to each other, and if they are equal to each other, the present drive conditions are made to be maintained. In contrast thereto, if the effective value Vea in the first period is lower than the effective value Veb in the second period, the resistance value of the variable resistor 1 is made to decrease to thereby increase the emission intensity of the light emitting element 141 in the first period. Further, if the effective value Veb in the second period is lower than the effective value Vea in the first period, the resistance value of the variable resistor 2 is made to decrease to thereby increase the emission intensity in the second period. Then, the adjustment amount in the case in which the effective values Vea, Veb become eventually in the same level is used for the calculation of the position information.

### Configuration of Light Detector of Present Embodiment

Then, the configuration of the light detector 410 in the embodiment described above will be explained in detail. FIGS. 6A and 6B are for showing the structure and the positional relationship of the reference surface 200P and the light detector 410 according to the present embodiment, wherein FIG. 6A is a schematic cross-sectional view schematically showing the structure thereof, and FIG. 6B is an explanatory diagram for explaining the positional relationship therebetween. The light detector 410 has a light receiving section 411 incorporating the light receiving element 410d and provided with a light detection surface 411a having sensitivity to the position detection light beam, and alight blocking member 412 covering the light detection surface 411a of the light receiving section 411 and having an opening section 412a on the detection space S side of the light detection surface 411a. A distance (x2 described later) is provided between the light detection surface 411a and the opening section 412a in a direction along the reference surface 200P.

The light blocking member 412 is made of a material for blocking the position detection light beam L2. Further, it is preferable that the inner surfaces (the surfaces existing inside the light blocking member 412) 412b of the light blocking member 412 are made of a material absorbing the position detection light beam L2 but not substantially reflecting the position detection light beam L2. The reflectance of the inner surfaces 412b is set to 20% or lower, preferably 10% or lower, and desirably 5% or lower. In the case in which both of the light blocking property of the light blocking member 412 and the surface characteristic of the inner surfaces 412b cannot be satisfied at the same time, it is possible to cover the inner surfaces 412b with the layer absorbing the position detection light beam L2 but not substantially reflecting the position detection light beam L2 described above.

Here, as shown in FIG. 6A, in the reference surface 200P, a far side boundary point Pa located at a position furthest from the opening section 412a with respect to an arbitrary direction on the reference surface 200P is considered. The far side boundary point Pa exists on an outer edge of the reference surface 200P located on the opposite side to the opening section 412a. Further, a straight line Lp is drawn from the far side boundary point Pa to the opening edge of the opening section 412a on the side of the reference surface 200P. On this occasion, since the opening section 412a has a predetermined opening area, an infinite number of such straight lines as describe above can be set. However, in this case, the straight line passing through the edge point Pc on the opening edge of the light blocking member 412 on the side of the reference surface 200P out of the opening section 412a is taken as the straight line Lp. Further, the point where the straight line Lp intersects the light detection surface 411a or the extended surface thereof is defined as a reached point Pd.

Then, the X-axis is set along the projection line obtained by projecting the straight line Lp on the reference surface 200P, the Y-axis is set in a direction perpendicular to the X-axis on the reference surface 200P, and the Z-axis is set in a direction perpendicular to the reference surface 200P. On this occasion, it is assumed that the distance between the far side boundary point Pa and the edge point Pc measured along the X-axis (the reference surface 200P) is x1, and the distance between the edge point Pc and the reached point Pd measured along the X-axis (the reference surface 200P) is x2. Further, it is assumed that the distance between the reference surface 200P and the edge point Pc measured along the Z-axis (the direction perpendicular to the reference surface 200P) is z1, and the distance between the edge point Pc and the outer edge position 411b of the light detection surface 411a on the opposite side to the reference surface 200P measured along the Z-axis (the direction perpendicular to the reference surface 200P) is z2. Further, it is assumed that the distance between the edge point Pc and the reached point Pd measured along the Z-axis (the direction perpendicular to the reference surface 200P) is z2′ (see FIG. 6B).

In this case, as can be understood with reference to FIG. 6B, since x1:z1=x2:z2′ is satisfied, z2′=z1·x2/x1 is obtained. Here, if z2′≧z2 is satisfied, the position detection light beam L2 emitted from the reference surface 200P and entering the opening section 412a enters the side further from the reference surface 200P than the outer edge position 411b of the light detection surface 411a, and therefore, the position detection light beam L2 directly emitted from the reference surface 200P is blocked by the light blocking member 412, and fails to enter the light detection surface 411a. Therefore, if the formula 1 described below is satisfied, the position detection light beam L2 emitted from the reference surface 200P along the projection line of the straight line Lp and directly entering the light detection surface 411a disappears, as a result.

z2≦z1·x2/x1 (1)

It should be noted that whether or not the formula 1 is satisfied is determined assuming that z2 takes a positive value if the outer edge position 411b is located on the side opposite to the reference surface 200P from the edge point Pc.

It should be noted that the edge point Pc, the reached point Pd, and the straight line Lp corresponding to these points can be set in any directions from the light detector 410 to the detection space S. In other words, the projection line of the straight line Lp with respect to the reference surface 200P can be set on the X-Y plane in an arbitrary planar direction. Further, if the edge point Pc, the reached point Pd, and the straight line Lp described above are set in all of the planar directions from the light detection surface 411a toward the opening section 412a along the reference surface 200P, namely in all of the planar directions within a range in which the direction intersecting the light detection surface 411a in a plan view out of the planar directions along the reference surface 200P, and the formula 1 is satisfied in all of the cases, there is no chance for the light beam directly emitted from the reference surface 200P to directly enter the light detection surface 411a.

According to the configuration described above, since it becomes that there is no chance for the position detection light beam L2 emitted from the reference surface 200P set in the range from which the position detection light beam L2 is emitted out of the front surface 200A of the screen 200 to directly enter the light detection surface 411a, an influence of the light other than the reflected light beam R2 from the detection target object 300 to the light detection value of the light detector 410 can be reduced, and therefore, it becomes possible to substantially improve the detection sensitivity of the light detector 410 to the reflected light beam R2, and thus, the accuracy of the position information of the detection target object 300 can be improved, as a result. In particular, by forming the inner surfaces 412b of the light blocking member 412 to be surfaces absorbing the position detection light beam L2 but not substantially reflecting it as described above, it becomes that the position detection light beam L2 entering from the reference surface 200P substantially fails to enter the light detection surface 411a.

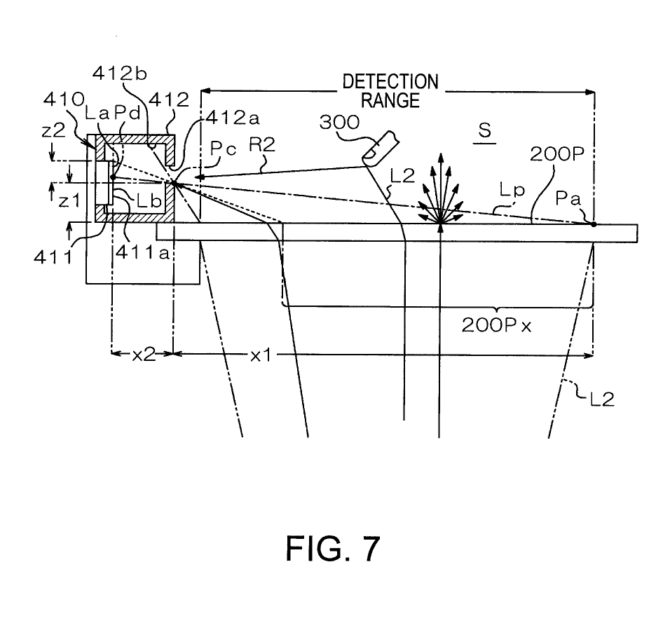

FIG. 7 is a schematic cross-sectional view schematically showing an embodiment different from the embodiment described above. In this embodiment, the reached point Pd is arranged to be located on the side of the reference surface 200P from the outer edge position 411b of the light detection surface 411a on the opposite side to the side of the reference surface 200P. In other words, in the present embodiment, the formula 1 is not satisfied in at least either one (the lateral direction in FIG. 7) of the planar directions from the light detection surface 411a toward the opening section 412a along the reference surface 200P, and the outer edge position 411b is set at a position further from the reference surface 200P than in the case shown in FIGS. 6A and 6B. Therefore, the position detection light beam L2 emitted from the range 200Px near to the far side boundary point Pa out of the reference surface 200P enters the area La located on the side further from the reference surface 200P than the reached point Pd out of the light detection surface 411a via the opening section 412a.

However, also in this case, since the position detection light beam L2 emitted from the range outside the range 200P out of the reference surface 200P fails to enter the light detection surface 411a, and further, the position detection light beam L2 emitted from the reference surface 200P fails to enter the region Lb located on the side of the reference surface 200P from the reached point Pd out of the light detection surface 411a, it is possible to substantially improve the detection sensitivity of the light detector 410 to the reflected light beam R2, and as a result, the accuracy of the position information of the detection target object 300 can be improved compared to the case without the light blocking member 412.

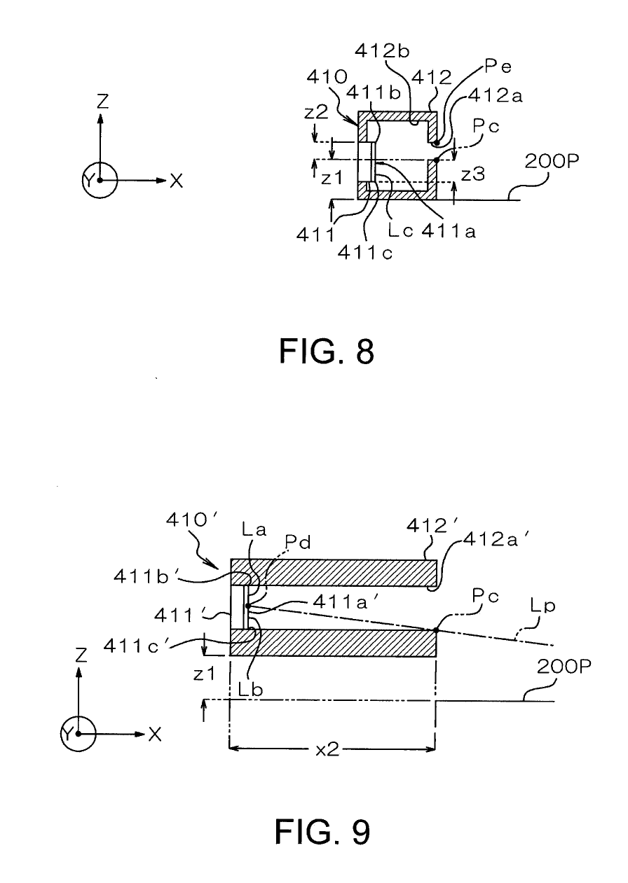

FIG. 8 is a schematic cross-sectional view showing a structure of the light detector 410 in each of the embodiments described above. In either one of the embodiments described above, the light detection surface 411a is provided with apart Lc located on the side of the reference surface 200P from the edge point Pc on the opening edge of the opening section 412a on the reference surface side. In other words, the outer edge position 411c of the light detection surface 411a on the side of the reference surface 200P is disposed on the side of the reference surface 200P from the edge point Pc. In the example shown in the drawing, the distance between the outer edge position 411c of the light detection surface 411a located on the side of the reference surface 200P and the edge point Pc on the opening edge measured along the Z-axis (the direction perpendicular to the reference surface 200P) is shown as z3.

According to the configuration described above, the position detection light beam L2 to be input to the part Lc from the side of the reference surface 200P is not input directly to the part Lc, on the one hand, the reflected light beam R2 reflected by the detection target object 300 at a position (further from the reference surface 200P than the edge point Pc on the opening edge) further from the reference surface 200P than the opening section 412a is input to the part Lc, and therefore, the detection sensitivity of the light detector 410 to the reflected light beam R2 is substantially improved as a result, and the accuracy of the position information of the detection target object 300 can be improved as a result.

It should be noted that in order for satisfying (in the case shown in FIGS. 6A and 6B) the formula 1, or for reducing (in the case shown in FIG. 7) the area of the region La described above, it is preferable that the outer edge position 411b of the light detection surface 411a on the opposite side to the reference surface 200P is located nearer to the reference surface 200P than the edge point Pe on the opening edge of the opening section 412a on the opposite side to the reference surface 200P.

Further, in each of the embodiments, the light blocking member 412 is configured to completely cover the light detection surface 411a except the opening section 412a. Thus, since the range of the incident angle of the light beam proceeding obliquely from the opposite side to the reference surface 200P toward the light detection surface 411a, and the range of the incident angle in the plane along the reference surface 200P can also be limited by the light blocking member 412, it becomes possible to substantially improve the detection sensitivity of the light detector 410 to the reflected light beam R2, and as a result, to improve the accuracy of the position detection of the detection target object 300. Further, in this case, since the range of the detection space S where the detection target object can be detected can be limited by the opening range of the opening section 412a, it can also be prevented that the position of the detection target object 300 not pointing at the reference surface 200P is mistakenly detected, or that the position of a region of the detection target object other than the pointing region is mistakenly detected.

FIG. 9 is a cross-sectional view showing the structure of a light detector 410′ according to a further different embodiment. The light detector 410′ of this embodiment is the same as each of the embodiments described above in the point that the light detection surface 411a′ of the light receiving section 411′ and the opening section 412a′ are distant from each other in a direction along the reference surface 200P, and is different therefrom in the point that the light detection surface 411a′ and the opening section 412a′ are substantially the same in the opening area and the opening shape, there is provided a structure in which the light detection surface 411a′ is directly opened to the side of the detection space S, there is no distance in the Z-axis direction between the edge point Pc on the opening edge of the opening section 412a′ and the outer edge position 411c′ of the light detection surface 411a′ on the side of the reference surface 200P, and z3=0 is achieved. It should be noted that in the present embodiment, there is no distance in the Z-axis direction with the outer edge position 411b′ of the light detection surface 411a′ on the side opposite to the reference surface 200P.

Also in the structure of such alight detector 410′, the region Lb of the light detection surface 411a located on the side of the reference surface 200P from the reached point Pd of the straight line Lp. In particular, by sufficiently providing at least either one of the distances z1 and x2, it is possible to expand the range of the region Lb, or to configure the structure so that the position detection light beam L2 emitted from the reference surface 200P does not at all enter the light detection surface 411a as the case of the embodiment shown in FIGS. 6A and 6B.

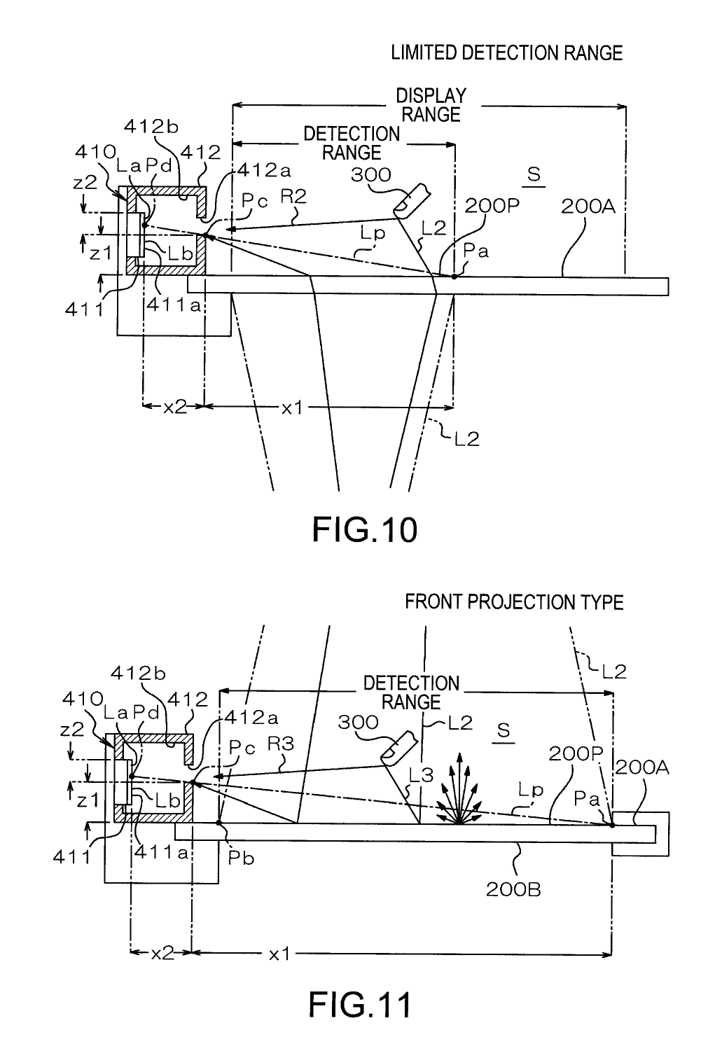

FIG. 10 shows still another embodiment in which the position detection range set in accordance with the irradiation range of the position detection light beam L2 and the image display range set in accordance with the irradiation range of the image display light beam L1 are different from each other. Although in this example the image display range and the position detection range partially overlap each other, it is possible to adopt a configuration in which the both ranges do not at all overlap each other. Further, although the position detection range is set as a part of the image display range, it is also possible to set the position detection range to be larger than the image display range on the contrary.

In the present embodiment, the position detection range is limited to the side of the light detector 410 with respect to the image display range, thereby disposing the far side boundary point Pa at a position nearer to the side of the light detector 410 than the far side region of the image display range. Therefore, since the tilt angle of the straight line Lp with the reference surface 200P can be set larger, it becomes easy to reduce or eliminate the region La of the light detection surface 411a to which the position detection light beam L2 emitted from the reference surface 200P is directly input.

FIG. 11 shows a different embodiment in which the image projection device 100 is disposed so as to be opposed to the front surface 200A of the screen 200, thereby modifying the rear projection display device into a normal (front) projection display device. In the present embodiment, the position detection light beam L2 is emitted directly toward the reference surface 200P. Further, in this case, it is preferable that the reference surface 200P is made of a material reflecting the position detection light beam L2. According to this configuration, since the position detection light beam L2 is reflected by the reference surface 200P to generate the position detection light beam L3 shown in the drawing, it is possible to efficiently set the reflection direction of the reflected light beam R3 of the position detection light beam L3 due to the detection target object 300 disposed in the detection space S to the light detector 410 similarly to the embodiments described above.

In particular, it is preferable that the reflective property of the reference surface 200P to the position detection light beam L2 does not function as a specular reflection surface, but functions as a diffuse reflection surface. According to such a configuration, since the emission angle distribution of the detection light beam L3 emitted from the reference surface 200P becomes a wide range distribution, the position detection of the detection target object 300 can be performed more surely and accurately irrespective of the posture of the detection target object 300 in the detection space S. Further, it is also possible to adopt a configuration in which, even if a region which the position detection light beam L2 fails to reach is formed in a part of the detection space S due to the shadow of the user, the position detection of the detection target object 300 disposed in the region becomes possible using the position detection light beam L3 due to the diffuse reflection of the position detection light beam L3.

Also in the present embodiment, since the position detection light beam L3 is emitted from the reference surface 200P and proceeds toward the light detector 410 similarly to the position detection light beam L2 in each of the embodiments described above, the situation becomes substantially the same as in the embodiments described above, and therefore, by using the structure of the light detector 410 described above, substantially the same advantages as described above can be obtained on the ground that the influence due to the position detection light beam L3 emitted from the reference surface 200P and directly entering the light detection surface 411a can be reduced or eliminated. It should be noted that the reflected light beam obtained by the detection target object 300 in the present embodiment can be either one of the reflected light beam R2 generated by reflecting the position detection light beam L2 and the reflected light beam R3 obtained by reflecting the position detection light beam L3.

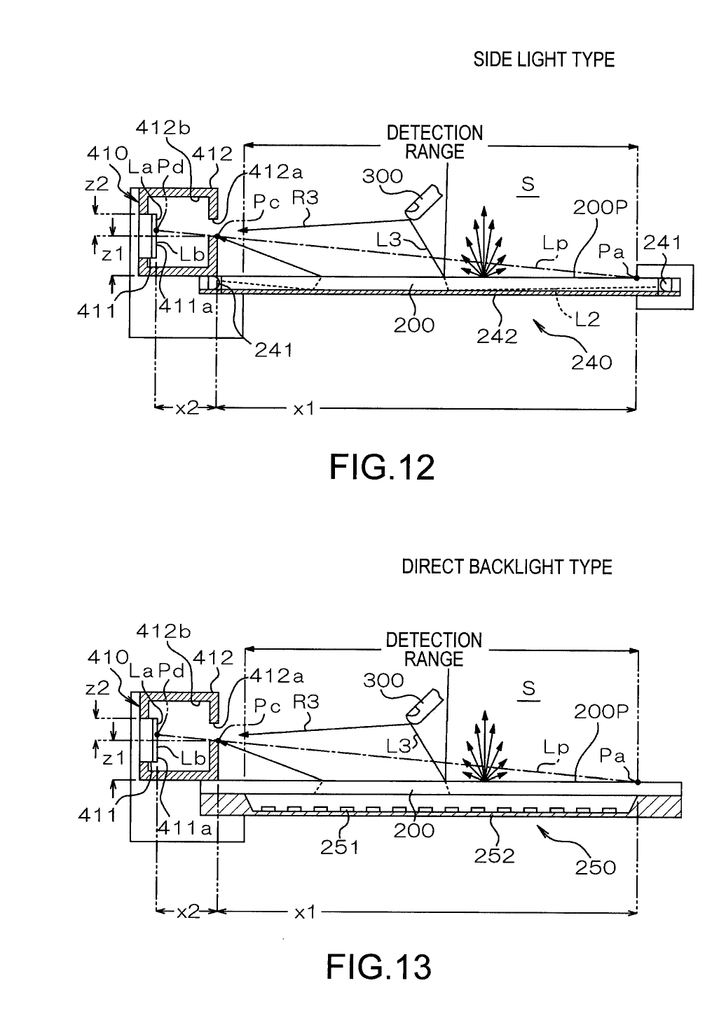

FIG. 12 is a schematic vertical cross-sectional view showing a further different embodiment in which the position detection light source section is provided to the screen. In the present embodiment, instead of providing the position detection light source section 140 to the image projection device 100 as in the embodiments described above, a plurality of position detecting light sources 241 constituting the position detection light source section 240 is disposed at positions opposed to edge faces of the screen 200. The screen 200 is configured as a light guide plate made of acrylic resin or polycarbonate resin, and the light guide plate is configured so as to gradually emit the light beam, which enters inside from the edge faces, from the reference surface 200P while guiding the light beam to propagate along the reference surface 200P.

In the present embodiment, in the configuration of the front projection type shown in FIG. 11, by disposing a reflecting plate (a reflecting layer) 242 on the rear surface 200B of the screen 200 configured as the light guide plate, it is possible to efficiently emit the position detection light beam L2, thus input, from the reference surface 200P. It should be noted that it is also possible to deflect the position detection light beam L2 toward the reference surface 200P by, for example, providing fine irregularities to the rear surface 200B or forming a light scattering pattern, which is formed by printing, on the rear surface 200B without providing the reflecting plate 242. According to such a configuration, applications to the rear projection configuration as shown in FIGS. 6A, 6B, and 7 becomes possible.

Although in the present embodiment the plurality of position detecting light sources 241 is disposed in each of the peripheral sides of the screen 200, the position detecting light sources can also be disposed in some of the sides of the screen 200. For example, it is also possible to dispose the position detection light source section 240 inside the detection device 400, and dispose one or more position detecting light sources 241 along the edge face of the screen 200 on the side of the detection device 400. It should be noted that in either case in the present embodiment the position detection light source section 240 has a side-light type backlight structure in which the light emitting elements 241 are disposed on the lateral side portion of the screen 200.

FIG. 13 is a schematic vertical cross-sectional view showing a further different embodiment in which the position detection light source section 250 is provided to the screen 200. In the present embodiment, the image projection device 100 forms a front projection display device having the image projection device 100 disposed so as to be opposed to the front surface 200A of the screen 200. In the present embodiment, light emitting elements 251 of the position detection light source section 250 are disposed so as to be opposed to the rear surface 200B of the screen 200. In this case, the position detection light source section 250 is provided with a plurality of position detecting light sources 251 disposed in the rear of the screen 200, and a housing section 252 for housing the position detecting light sources 251 and provided with reflecting inner surfaces. The screen 200 is configured as a light scattering plate made of, for example, acrylic resin or polycarbonate resin. The position detection light beam L2 emitted from the light emitting elements 251 enters the inside from the rear surface 200B of the screen 200, and is then emitted from the reference surface 200P in the front surface 200A. In the present embodiment the position detection light source section 250 has a direct backlight structure in which the light emitting elements 251 are disposed in the rear of the screen 200.

It should be noted that in the invention it is possible to appropriately combine the constituents described in the above embodiments to configure other embodiments. Further, as long as the optical relationship is maintained, the physical configuration of the position detection light source section and the light detector can arbitrarily be selected such that the position detection light source section and the light detector can be provided to either of the image projection device 100 and the screen 200. For example, although not shown in the embodiments described above, if the configuration is disposed on the lateral side of the detection space S, the light detector can be provided to the image projection device 100 instead of providing it to the detection device 400.

### Advantages of Embodiments

According to the embodiments described hereinabove, the position information of the detection target object 300 can be detected using the position detection light beam based on the reflected light beam R2 by the detection target object 300. On this occasion, in the present embodiment, since the position detection light beam emitted from the reference surface 200P is prevented from directly entering at least a part of light detection surface 411a of the light detector 410 due to the light blocking structure constituted by the light blocking member 412, the detection sensitivity to the reflected light beam R2 can be improved, and thus the accuracy of the position information of the detection target object can be improved eventually.

Further, by configuring the light blocking structure with the light blocking member 412 provided with the opening section 412a formed with a distance from the light detection surface 411a on the side of the detection space S, it is possible to easily limit the incident angle range of the position detection light beam with respect to the light detection surface 411a. In particular, since the incident angle range can be limited with respect to the directions other than the direction toward the reference surface 200P by adopting the configuration in which the light blocking member 412 surrounds the entire periphery of the opening section 411a to thereby entirely cover the light detection surface 411a except the opening section 411a, the advantages described above can further be enhanced. Further, by adopting the surfaces absorbing but not substantially reflecting the position detection light beam L2 as the inner surfaces 412b of the light blocking member 412, the detection accuracy of the reflected light beam R2 can further be enhanced.

In the configuration shown in FIG. 10, since the reference surface 200P is limited to the side of the light detector 410 from the far side region of the image projection range on the opposite side to the light detector 410 out of the front surface 200A, the range in which the position detection light beam L2 is emitted from the reference surface 200P is limited to the side of the light detector 410. Therefore, it becomes possible to easily perform the light blocking of the position detection light beam L2 emitted from the reference surface 410.

Further, since the position detection light source section 140 is provided to the image projection device 100, it becomes easy to irradiate the range in the screen 200 overlapping the image projection range by the image projection device 100 with the position detection light beam L2. Further, since the light detector 410 is attached to the screen 200, the light detector 410 can easily be disposed and fixed on the lateral side of the detection space S.

It should be noted that the optical position detection device and the projection display device according to an aspect of the invention are not limited only to the illustrative embodiments described above, but it is obvious that various modifications can also be applied thereto within the scope or the spirit of the invention. For example, although in the illustrative embodiments the opening section 412a opens to the detection space S in a direction parallel to the reference surface 200P, and the light detection surface 411a is installed with a posture perpendicular to a direction parallel to the reference surface 200P, the invention is not limited to such a configuration, but it is also possible to open in an oblique direction, and to be installed with an oblique posture.

The entire disclosure of Japanese Patent Application No. 2009-279205, filed Dec. 9, 2009 is expressly incorporated by reference herein.

What is claimed is:

1. An optical position detection device comprising:
a light source section adapted to emit a position detection light beam to form a light intensity distribution in which the intensity varies along a reference surface;
a light detection section adapted to detect the position detection light reflected by a detection target object located in a detection space in which the light intensity distribution is formed; and
a position detection section adapted to detect a position of the detection target object based on a detection value of the light detection section,
wherein the light detection section has a light receiving section provided with a light detection surface, and a light blocking section adapted to block a part of the position detection light, and
the light blocking section has an opening section disposed between the detection space and the light detection surface with a distance from the light detection surface.

2. The optical position detection device according to claim 1, wherein
the light detection surface has a part disposed on a side of the reference surface from an edge of the opening section viewed from a direction along the reference surface.

3. The optical position detection device according to claim 2, wherein
the light detection surface is covered by the light blocking section except the opening section.

4. The optical position detection device according to claim 3, wherein
the light blocking section has an inner surface absorbing the position detection light.

5. The optical position detection device according to claim 1, wherein
assuming that a length of a projection line of a straight line to the reference surface is x1, the straight line connecting a far side boundary point on a boundary line of the detection space obtained by projecting the detection space to the reference surface and the opening edge of the opening section on the reference surface side, the far side boundary point being the furthest from the opening section,
a length of a projection line of a straight line to the reference surface is x2, the straight line connecting the opening edge and the light detection surface,
a distance from the opening edge to the reference surface along a direction perpendicular to the reference surface is z1, and
a distance from an outer edge position of the light detection surface on an opposite side to the reference surface to the opening edge along a direction perpendicular to the reference surface is z2,
z2≦z1·x2/x1 is satisfied.

6. The optical position detection device according to claim 1, wherein
the reference surface is composed of at least a part of a surface of a light guide member, and
the position detection light beam is emitted from the reference surface.

7. A projection display device comprising:
the optical position detection device according to claim 1;
a screen provided with the reference surface; and
an image projection device adapted to project an image to the screen.

8. The projection display device according to claim 7, wherein
the light source section is attached to the image projection device.

9. The projection display device according to claim 7, wherein
the light detection section is attached to the screen.
